(19) United States
(12) Patent Application Publication
(10) Pub. No.: US 2015/0246450 A1
(43) Pub. Date: Sep. 3, 2015

(54) ROBOT WITH FIXING DEVICE FOR RESTRICTING RELATIVE ROTATING MOTION OF TWO MEMBERS AND SUCH FIXING DEVICE

(71) Applicant: FANUC CORPORATION, Yamanashi (JP)

(72) Inventor: Keishi Yoneda, Yamanashi (JP)

(21) Appl. No.: 14/630,759

(22) Filed: Feb. 25, 2015

(30) Foreign Application Priority Data
Feb. 28, 2014 (JP) 2014-039387

(51) Int. Cl. B25J 19/00; B25J 19/06; B25J 17/00

(52) U.S. Cl. CPC B25J 19/0066; B25J 17/00; B25J 19/0004; B25J 19/06; Y10S 901/28; Y10S 901/49

(57) ABSTRACT

A robot of the present invention includes a swivel base and lower arm which are connected to be able to rotate relative to each other about a rotation axis, and a fixing device which restricts rotating motion of the swivel base and lower arm about the rotation axis. The fixing device includes a mounting part which is mounted to the swivel base, and an abutting part which extends from the mounting part and abuts against the lower arm to restrict relative rotating motion about the rotation axis. An abutting position of the abutting part with respect to the lower arm can be changed steplessly in a circumferential direction about the rotation axis.

### BACKGROUND OF THE INVENTION

1. Field of the Invention

The present invention relates to a robot with a fixing device for restricting relative rotating motion of two members, and to a fixing device for restricting relative rotating motion of two members.

2. Description of the Related Art

Vertical articulated robots often employ servo motors with built-in brakes as means for driving the arms. These vertical articulated robots are configured to automatically activate the brakes of the servo motors to prevent dropping of the arms due to gravity when the drive currents of the servo motors are cut off. On the other hand, while a servo motor is being replaced due to breakdown or other reason, it is necessary to use a means for temporarily preventing the dropping of the arm in place of the servo motor. In such a case, for example, a ceiling crane may be used to suspend the arm from above, or any support platform may be used to support the arm.

In this regard, since the arm of a vertical articulated robot operates against gravity, various gravity balance devices using coil springs etc. may be employed to reduce the load on the servo motor. Such a gravity balance device is illustrated in JP-A-2002-283274. If a servo motor is detached for the purpose of repair or replacement etc. from a vertical articulated robot with a gravity balance device, the arm may spring upward, instead of dropping downward, depending on the weight of the hand and workpiece which are attached to the arm and the angular position of the arm. This is because the torque of the gravity balance device which pulls up the arm may become larger than the gravitational torque which drops the arm down. It is not easy to predict whether the arm will drop down or be lifted, and therefore, measures for restricting rotating motion of the arm in both directions are installed, in consideration of safety. In this case, the arm is, for example, simultaneously suspended from above by a ceiling crane and pulled from below by a chain block. In this respect, since a servo motor may possibly break down at any angular position of the arm, so depending on the angular position of the arm, access to a ceiling crane may be difficult and there will not be a suitable installation location of the chain block on the floor.

In relation to this, JP-A-2002-283274 proposes the art of using a fastening fixture which restricts motion of a shaft of a gravity balance device so as to fix the arm connected to that shaft. However, the art of JP-A-2002-283274 can only be applied to robots with a gravity balance device, and hence lacks versatility. An articulated robot may also be provided with stoppers for restricting the operating angle of the arm, and it is possible in principle to fix the arm in place, using such stoppers. However, the above stoppers need to be located at predetermined positions which correspond to the allowable operating angle of the arm, and therefore it would not be possible to fix the arm at an arbitrary angular position even if these stoppers are used.

A robot and fixing device which are capable of fixing an arm at an arbitrary angular position even without an aid of a ceiling crane or chain block or other unwieldy equipment, have been sought.

### SUMMARY OF INVENTION

According to a first aspect of the present invention, there is provided a robot comprising: a first member and a second member which are connected to be able to rotate relative to each other about a predetermined rotation axis; and a fixing device which restricts relative rotating motion of the first member and the second member about the rotation axis, wherein the fixing device includes: a mounting part which is mounted to the first member; and an abutting part which extends from the mounting part and abuts against the second member to restrict relative rotating motion, and an abutting position of the abutting part with respect to the second member can be changed steplessly in a circumferential direction about the rotation axis.

According to a second aspect of the invention, there is provided a robot in the first aspect, wherein the mounting part has a long hole which extends in the circumferential direction and is mounted to the first member by a plurality of screws which are inserted in the long hole, and the mounting position of the mounting part to the first member can be changed steplessly along the extension direction of the long hole.

According to a third aspect of the invention, there is provided a robot in the first aspect, wherein the mounting part and the abutting part are formed of separate members which are connected with each other, and the abutting part can be moved steplessly with respect to the mounting part in a direction toward an abuttable part of the second member and a direction away from the abuttable part.

According to a fourth aspect of the invention, there is provided a robot in any of the first to third aspects, further comprising a pair of fixing devices which are arranged one by one at both sides in the circumferential direction of the abuttable part of the second member.

According to a fifth aspect of the invention, there is provided a robot in any of the first to third aspects, wherein the fixing device includes a pair of abutting parts which are arranged one by one at both sides in the circumferential direction of the abuttable part of the second member.

According to a sixth aspect of the invention, there is provided a robot in any of the first to fifth aspects, further comprising a third member which can be attached to the first member, wherein the mounting part is mounted by means of the third member to the first member.

According to a seventh aspect of the present invention, there is provided a fixing device for restricting relative rotating motion about a predetermined rotation axis, of a first member and a second member of a robot which are connected to be able to rotate relative to each other about the rotation axis, comprising: a mounting part which has a long hole which extends in an arc shape and which can be mounted to the first member by a plurality of screws which are inserted in the long hole; and an abutting part which extends from the mounting part and abuts against the second member to restrict the relative rotating motion, wherein a mounting position of the mounting part by the plurality of screws can be changed steplessly along an extension direction of the long hole.

According to an eighth aspect of the present invention, there is provided a fixing device for restricting relative rotating motion about a predetermined rotation axis, of a first member and a second member of a robot which are connected to be able to rotate relative to each other about the predetermined rotation axis, comprising: a mounting part which can be mounted to the first member; and an abutting part which extends from the mounting part and abuts against the second member to restrict the relative rotating motion, wherein the mounting part and the abutting part are formed of separate members which are connected to each other, and the abutting part can move steplessly with respect to the mounting part in a direction toward an abuttable part of the second member and a direction away from the abuttable part.

According to a ninth aspect of the invention, there is provided a fixing device in the eighth aspect, wherein the abutting part is formed of a pair of members which are arranged so as to sandwich the abuttable part of the second member.

These and other objects, features, and advantages of the present invention will become clearer with reference to the detailed description of illustrative embodiments of the present invention which are shown in the attached drawings.

### BRIEF DESCRIPTION OF THE DRAWINGS

FIG. 1 is a side view which shows an appearance of an illustrative robot of a first embodiment of the present invention.

FIG. 2 is a partial enlarged view which shows fixing devices and their vicinities in the robot of FIG. 1.

FIG. 3 is a partial enlarged view which shows fixing devices and their vicinities in the robot of a second embodiment.

FIG. 4 is a partial enlarged view similar to FIG. 3, which shows a modification of the robot of the second embodiment.

FIG. 5 is a partial enlarged view which shows a fixing device and its vicinity in the robot of a third embodiment.

FIG. 6 is a partial enlarged view similar to FIG. 2, which shows an illustrative robot of the first embodiment which employs a lower arm as the first member and a swivel base as the second member.

### DETAILED DESCRIPTION OF EMBODIMENTS

Below, embodiments of the present invention will be explained in detail with reference to the drawings. In the figures, similar components will be assigned similar reference notations. Note that the following explanation does not limit the technical scope of the inventions which are described in the claims or the meaning of terms etc.

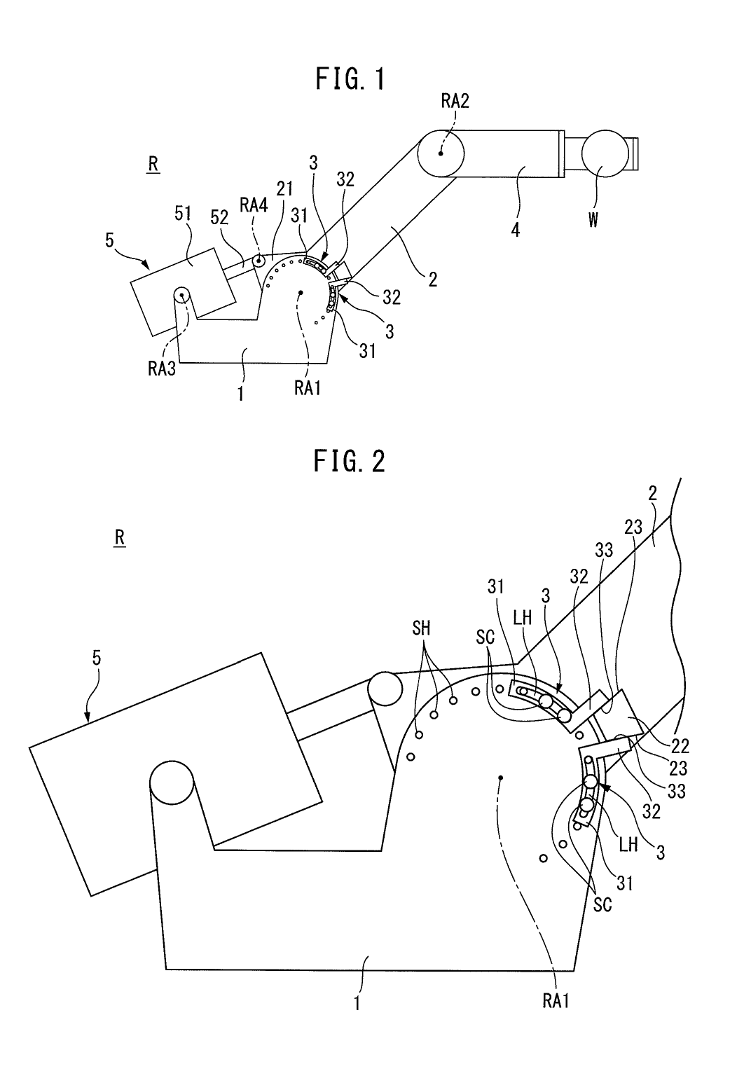

Referring to FIG. 1 and FIG. 2, a robot of a first embodiment of the present invention will be explained. FIG. 1 is a side view which shows the appearance of an illustrative robot R of the present embodiment. The robot of the present embodiment is an industrial robot with an arm to which various end effectors can be mounted, and comprises a first member and second member which are connected to be able to rotate relative to each other about a predetermined rotation axis, and a fixing device which restricts relative rotating motion of the first member and second member about the rotation axis.

More specifically, the robot R of the present example comprises a swivel base 1 which corresponds to the above-mentioned first member, a lower arm 2 which corresponds to the above-mentioned second member, and an upper arm 4 with a wrist W to which various end effectors can be mounted. As shown in FIG. 1, in the robot R of the present example, the swivel base 1 and the lower arm 2 are connected to be able to rotate relative to each other about a rotation axis RA1. Further, the drive power of a servo motor (not shown) is used to make the lower arm 2 swing with respect to the swivel base 1 about the rotation axis RA1. Similarly, the lower arm 2 and the upper arm 4 are connected to be able to rotate relative to each other about another rotation axis RA2. Further, the drive power of a servo motor (not shown) is used to make the upper arm 4 swing with respect to the lower arm 2 about a rotation axis RA2.

As shown in FIG. 1, the robot R of the present example also comprises a pair of fixing devices 3, 3 which restrict relative rotating motion of the swivel base 1 and lower arm 2 about the rotation axis RA1. Each of these fixing devices 3, 3 has a mounting part 31 which is mounted to the swivel base 1, and an abutting part 32 which extends from the mounting part 31 and abuts against the lower arm 2. As explained later, the abutting position of an abutting part 32 against the lower arm 2 can be steplessly changed in the circumferential direction about the rotation axis RA1.

Further, the robot R of the present example also comprises a gravity balance device 5 which partially cancels out the moment due to gravity which acts on the lower arm 2. More specifically, the gravity balance device 5 of this example is provided with a cylindrical case 51 which is connected with the swivel base 1 to be able to rotate relatively about a predetermined rotation axis RA3, and a shaft 52 which sticks out of one end face of the case 51 concentrically with the case 51. The shaft 52 of the present example is acted on by the biasing force of a coil spring (not shown) which is built into the case 51. The front end part of the shaft 52 is connected with the lower arm 2 to be able to rotate relatively about another rotation axis RA4. This ensures that the connected part 21 of the shaft 52 with the lower arm 2 is acted on by a force in the direction toward the case 51 due to the biasing force of the coil spring, and therefore the moment due to gravity which acts on the lower arm 2 is partially cancelled out.

FIG. 2 is a partial enlarged view which shows the pair of fixing devices 3, 3 and their vicinities in the robot R of FIG. 1. As shown in FIG. 2, the mounting part 31 at each fixing device 3 extends in an arc shape with a predetermined curvature. An abutting part 32 protrudes outward in the radial direction of the arc, from one end part in the extension direction of the mounting part 31. The abutting part 32 of the present example has an abutting face 33 which can abut against a projection shaped abuttable part 22 which is formed on the outer circumferential surface of the lower arm 2. The abutting part 32 is configured to restrict the relative rotating motion of the swivel base 1 and the lower arm 2 about the rotation axis RA1 by abutting against the abuttable part 22 of the lower arm 2 at the abutting face 33.

As shown in FIG. 2, the pair of fixing devices 3, 3 are arranged one by one at both sides of the abuttable part 22 in the circumferential direction about the rotation axis RA1. That is, the abutting face 33 of one fixing device 3 abuts against one side face 23 in the circumferential direction of the abuttable part 22, while the abutting face 33 of the other fixing device 3 abuts against the other side face 23 in the circumferential direction of the abuttable part 22. In this way, the pair of fixing devices 3, 3 can restrict relative rotating motion of the swivel base 1 and lower arm 2 in both directions around the rotation axis RA1. Therefore, the pair of fixing devices 3, 3 can restrict both relative rotating motion associated with a downward swinging motion of the lower arm 2, which may be caused by the gravity acting on the lower arm 2, and the relative rotating motion associated with upward swinging motion of the lower arm 2 which may be caused by the biasing force of the gravity balance device 5 acting on the lower arm 2. In this way, according to the pair of fixing devices 3, 3, the servo motor can be safely replaced even if the swinging direction of the lower arm 2 is unpredictable.

Next, referring to FIG. 2, a plurality of screw holes SH are formed on the mounting location of the fixing devices 3 to the swivel base 1 of the present example, so as to be arranged in the circumferential direction about the rotation axis RA1. More specifically, 16 screw holes SH are formed on the swivel base 1 of FIG. 2 so as to be arranged at equal intervals in the circumferential direction about the rotation axis RA1. Further, the mounting part 31 of the present example has a long hole LH of an arc shape which extends in the circumferential direction about the rotation axis RA1. The curvature of the long hole LH is equal to the curvature of the arc which connects the adjoining screw holes SH on the swivel base 1. Further, the mounting parts 31 of the present example are attached to the swivel base 1 by pluralities of mounting screws SC which are inserted in the long holes LH.

More specifically, two mounting screws SC are inserted in the long hole HL of each mounting part 31 in FIG. 2. These two mounting screws SC are respectively engaged with two adjoining screw holes SH on the swivel base 1. As shown in FIG. 2, the dimension of the long hole LH in its extension direction in the mounting part 31 of the present example is sufficiently larger than the length of the arc which connects two adjoining screw holes SH. The mounting position of the mounting part 31 to the swivel base 1 can therefore be changed steplessly along the extension direction of the long hole LH of the mounting part 31. Similarly, the abutting position of the abutting part 32 to the abuttable part 22 can also be changed steplessly along the extension direction of the long hole LH, that is, the circumferential direction about the rotation axis RA1.

In the above way, according to the robot R of the present example, it becomes possible to steplessly change the abutting positions of the fixing device mounted to the swivel base 1 against the lower arm 2 in the circumferential direction about the rotation axis RA1 of the swivel base 1 and lower arm 2. Therefore, according to the robot R of the present example, it becomes possible to fix the lower arm 2 at any angular position even without using a ceiling crane or chain block or other unwieldy equipment. Since it is not necessary to secure a large space around the robot R of the present example in this way, it is possible to use the robot even in an environment in which various pieces of peripheral equipment are densely arranged. Further, according to the robot R of the present example, it is possible to change the abutting positions of the abutting parts 32 by moving the mounting part 31 of each fixing device 3 along the extension direction of the long hole LH. Therefore, according to the robot R of the present example, it is possible to fix the lower arm 2 at any angular position by means of a fixing device 3 with a simplified structure.

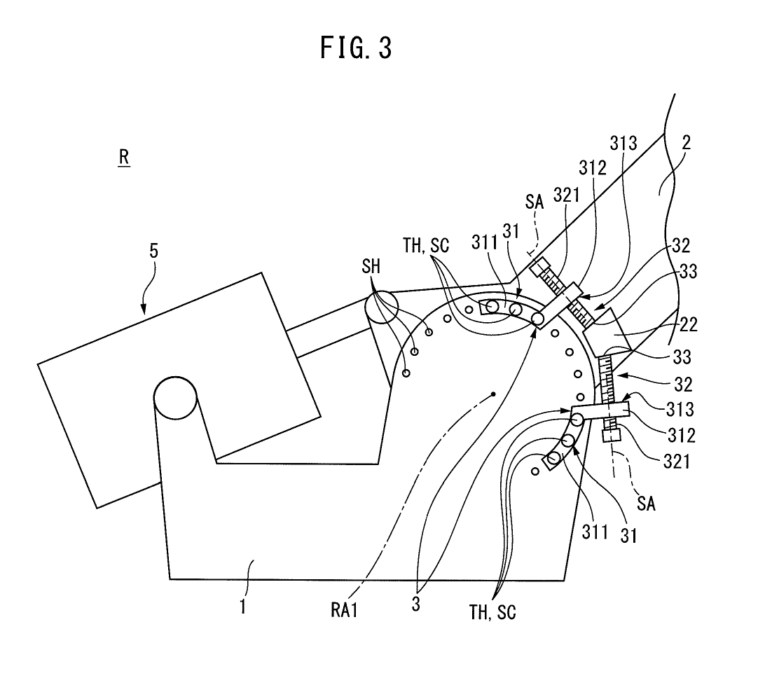

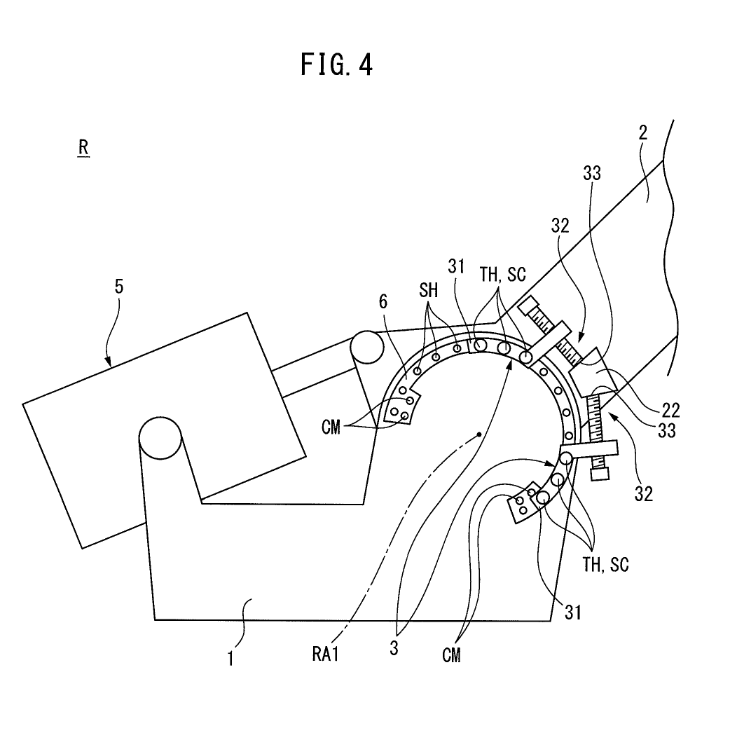

Next, referring to FIG. 3 and FIG. 4, a robot of a second embodiment of the present invention will be explained. The robot of the present embodiment has a similar configuration to the robot of the above-mentioned first embodiment except for the parts which are specifically explained below. Therefore, parts which have similar configurations to the first embodiment are assigned the same reference notations as the first embodiment and explanations of these parts having similar configurations will be omitted.

FIG. 3 is a partial enlarged view similar to FIG. 2 which shows a pair of fixing devices 3, 3 and their vicinities in an illustrative robot R of the present embodiment. As shown in FIG. 3, each of the fixing devices 3, 3 of the present example, in the same way as the example of FIG. 2, has a mounting part 31 which is mounted to the swivel base 1, and an abutting part 32 which extends from the mounting part 31 and abuts against the lower arm 2. However, unlike the example of FIG. 2, the mounting part 31 and abutting part 32 of the present example are formed of separate members which are connected with each other. Further, the abutting part 32 of the present example can steplessly move with respect to the mounting part 31 in a direction toward the abuttable part 22 of the lower arm 2 and in a direction away from the abuttable part 22. The structures of the different parts of the fixing devices 3 of the present example will be explained in detail below.

As shown in FIG. 3, each mounting part 31 of the present example has an arc part 311 which extends in an arc shape with a predetermined curvature, and a projecting part 312 which protrudes outward in the radial direction of the arc, from one end part in the extension direction of the arc part 311. A plurality of through holes TH are formed on the arc part 311 of the mounting part 31 of the present example so as to be arranged in the same way as the plurality of screw holes SH on the swivel base 1. Further, the mounting part 31 of the present example is mounted to the swivel base 1 by a plurality of mounting screws SC which are inserted in the plurality of through holes TH. More specifically, three through holes TH are formed on the arc part 311 of the mounting part 31 of the present example so as to be arranged in the same way as three adjoining screw holes SH on the swivel base 1. The three mounting screws SC which are inserted in these three through holes TH engage with three adjoining screw holes SH on the swivel base 1.

Next, referring to FIG. 3, a female screw 313 with an axis SA vertical to the rotation axis RA1 is formed on the projecting part 312 of the mounting part 31 in each fixing device 3 of the present example. Further, the abutting part 32, which is a separate member from the mounting part 31, has a rod shape which extends in one direction, and one end part in its extension direction is provided with an abutting face 33 which can abut against the abuttable part 22 of the lower arm 2. Further, as shown in FIG. 3, a male screw 321 is formed on the outer circumferential surface of the abutting part 32 of the present example, so as to engage with the female screw 313 of the mounting part 31 side.

Since, the abutting part 32 of the present example has the male screw 321 which engages with the female screw 313 of the mounting part 31 in this way, the abutting part 32 can be moved steplessly in a direction toward the abuttable part 22 and in a direction away from the abuttable part 22 by being rotated about the axis SA. Therefore, according to the fixing devices 3, 3 of the present example, it becomes possible to steplessly change the abutting position of the abutting part 32 against the abuttable part 22 in the circumferential direction about the rotation axis RA1 if the mounting part 31 is provided with a female screw 313 having a suitably oriented axis SA. For example, the axis SA of the female screw 313 can be oriented so as to be tangent to a virtual circle about the rotation axis RA1.

In the above way, according to the robot R of the present example, it is possible to fix the lower arm 2 at any angular position even without using a ceiling crane or chain block or other unwieldy equipment. Note that, in order to prevent shifting of the abutting position of the abutting part 32 due to vibration, etc., after fixing of the lower arm 2, a pair of locknuts (not shown) may be attached to the male screw 321 of the present example, so as to straddle the female screw 313. Further, according to the robot R of the present example, since the abutting part 32 of each fixing device 3 itself can be moved to change the abutting position of the abutting part 32 against the lower arm 2, it is possible to precisely change the abutting position of the abutting part 32. Further, since the pair of fixing devices 3, 3 are arranged at both sides of the abuttable part 22 in the circumferential direction about the rotation axis RA1, in the same way as the example of FIG. 2, it is possible to restrict relative rotating motion in both directions about the rotation axis RA1.

Next, a modification of the robot of the present embodiment will be explained. FIG. 4 is a partial enlarged view similar to FIG. 3 which shows a pair of fixing devices 3, 3 in the robot R of the present example. The pair of fixing devices 3, 3 of the robot R of the present example have configurations similar to the pair of fixing devices 3, 3 according to the example of FIG. 3. However, the pair of fixing devices 3, 3 according to the present example are mounted to the swivel base 1 by means of an attachment member 6 which is attached beforehand to the swivel base 1, instead of being directly mounted to the swivel base 1 as in the example of FIG. 3. More specifically, the attachment member 6 according to the present example extends in an arc shape with a predetermined curvature, and has a plurality of screw holes SH which are arranged along the extension direction. Further, three mounting screws SC are inserted in three through holes TH on each fixing device 3, so as to engage with three adjoining screw holes SH on the attachment member 6. Since, the pair of fixing devices 3, 3 of the present example are mounted to the swivel base 1 by means of the attachment member 6 in this way, it is possible to mount the pair of fixing devices 3, 3 to the swivel base 1 even if there are no screw holes on the swivel base 1 unlike the examples of FIG. 1 to FIG. 3. Note that, the attachment member 6 according to the present example can be attached to the swivel base 1 by a plurality of screws or other connecting members. However, the attachment member 6 may also be welded to the swivel base 1, or bonded to the swivel base 1 by various binders.

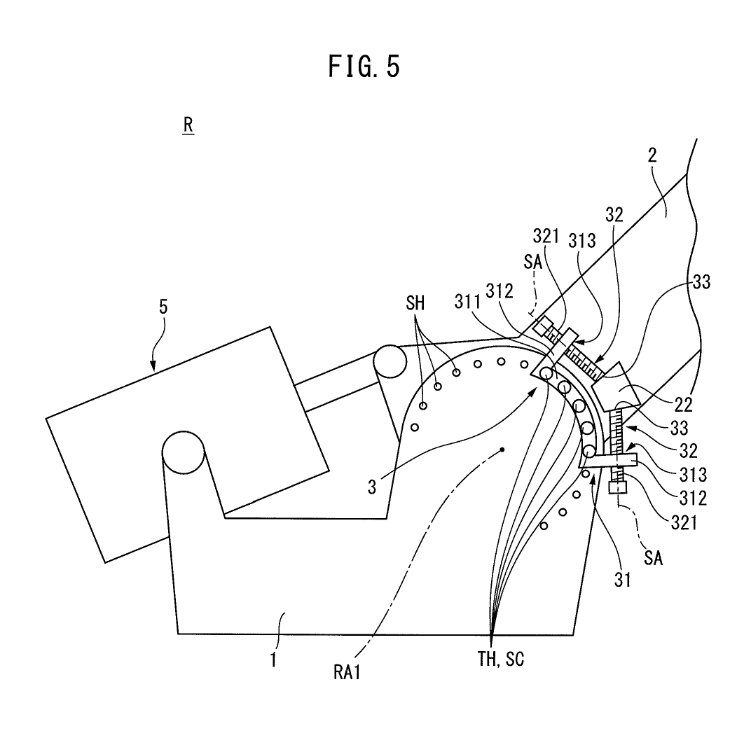

Next, referring to FIG. 5, a robot of a third embodiment of the present invention will be explained. The robot of the present embodiment has a similar configuration to the robot of the above-mentioned second embodiment except for the parts which are specifically explained below. Therefore, parts which have similar configurations to the second embodiment are assigned the same reference notations as the second embodiment and explanations of these parts having similar configurations will be omitted.

Unlike the robots of the first embodiment and second embodiment, the robot of the present embodiment comprises a single fixing device 3 which has a pair of abutting parts 32, 32, instead of a pair of fixing devices 3, 3. FIG. 5 is a partial enlarged view similar to FIG. 2 which shows the fixing device 3 and its vicinity in an illustrative robot R of the present embodiment. As shown in FIG. 5, the fixing device 3 of this example has a mounting part 31 which is mounted to the swivel base 1, and a pair of abutting parts 32, 32 which extend from the mounting part 31 and abut against the abuttable part 22 on the lower arm 2. The mounting part 31 of the present example and the pair of abutting parts 32, 32 are formed of separate members which are connected with each other. Each of the abutting parts 32, 32 can be moved steplessly with respect to the mounting part 31 in a direction toward the abuttable part 22 of the lower arm 2 and in a direction away from the abuttable part 22. The structures of the parts of the fixing device 3 of the present example will be explained in detail below.

As shown in FIG. 5, the mounting part 31 of the present example has an arc part 311 which extends in an arc shape with a predetermined curvature, one projecting part 312 which projects outward in the radial direction from one end part in the extension direction of the arc part 311, and another projecting part 312 which projects outward in the radial direction from the other end part in the extension direction of the arc part 311. A plurality of through holes TH are formed on the arc part 311 of the mounting part 31 of the present example, so as to be arranged in the same way as the plurality of screw holes SH on the swivel base 1. Further, the mounting part 31 of this example is mounted to the swivel base 1 by a plurality of mounting screws SC which are inserted in the plurality of through holes TH. More specifically, five through holes TH formed on the arc part 311 in the mounting part 31 of the present example so as to be arranged in the same way as five adjoining screw holes SH on the swivel base 1. The five mounting screws SC inserted in these five through holes TH engage with five adjoining screw holes SH on the swivel base 1.

Next, referring to FIG. 5, a female screw 313 with an axis SA vertical to the rotation axis RA1 is provided on each of the pair of projecting parts 312, 312 in the mounting part 31 of the present example. Further, each of the abutting parts 32, 32, which are formed of separate members from the mounting part 31, has a rod shape extending in one direction. One end part in the extension direction of the rod shape is provided with an abutting face 33 which can abut against the abuttable part 22 on the lower arm 2. Further, as shown in FIG. 5, a male screw 321 is formed on the outer circumferential surface of each of the pair of abutting parts 32, 32, so as to engage with the female screw 313 on the mounting part 31.

Since, each of the abutting parts 32, 32 has a male screw 321 which engages with the female screw 313 on the mounting part 31 in this way, it can be moved steplessly in a direction toward the abuttable part 22 and in a direction away from the abuttable part 22 by being rotated about the axis SA. Therefore, according to the fixing device 3 of the present example, it becomes possible to steplessly change the abutting position of each abutting part 32 with respect to the abuttable part 22 in the circumferential direction about the rotation axis RA1 if each projection part 312 is provided with a female screw 313 having a suitably oriented axis SA. For example, the axis SA of the female screw 313 can be oriented so as to be tangent to a virtual circle about the rotation axis RA1.

As explained above, according to the robot R of the present example, it becomes possible to fix the lower arm 2 at any angular position even without using a ceiling crane or chain block or other unwieldy equipment. Note that, in order to prevent shifting of the abutting position of the abutting part 32 due to vibration etc. after fixing of the lower arm 2, a pair of locknuts (not shown) may be attached to the male screw 321 of the present example, so as to straddle the female screw 313. Further, according to the robot R of the present example, since the abutting part 32 of each fixing device 3 itself can be moved to change the abutting position of the abutting part 32 against the lower arm 2, it is possible to precisely change the abutting position of the abutting part 32. Further, since the pair of fixing devices 3, 3 are arranged at the both sides of the abuttable part 22 in the circumferential direction about the rotation axis RA1 as shown in FIG. 5, it is possible to restrict relative rotating motion in both directions about the rotation axis RA1.

Effect of Invention

According to the first aspect of the present invention, in a robot comprising a first member and a second member which are connected to be able to rotate relative to each other, it is possible to steplessly change the abutting position of a fixing device which is mounted to the first member against the second member in the circumferential direction about the rotation axis. Therefore, according to the first aspect of the present invention, it becomes possible to fix the arm of a robot at any angular position even without using a ceiling crane or chain block or other unwieldy equipment.

According to the second and seventh aspects of the present invention, the mounting part of a fixing device can be moved along an extension direction of a long hole so as to change the abutting position of the abutting part against the second member. Therefore, according to the second and seventh aspects of the present invention, it is possible to fix the arm at any angular position, using a fixing device with a simplified structure.

According to the third and eighth aspects of the present invention, the abutting part of a fixing device itself can be moved to change an abutting position of the abutting part. Therefore, according to the third and eighth aspects of the present invention, it is possible to precisely change the abutting position of the abutting part.

According to the fourth, fifth, and ninth aspects of the present invention, a pair of abutting parts are arranged one by one at both sides in the circumferential direction of the abuttable part of the second member, so as to abut against the abuttable part of the second member, and therefore it is possible to restrict relative rotating motion in both directions about the rotation axis.

According to the sixth aspect of the present invention, a fixing device is mounted to the first member by means of a third member, and hence there is no longer a need to provide a special mounting mechanism for mounting the fixing device to the first member.

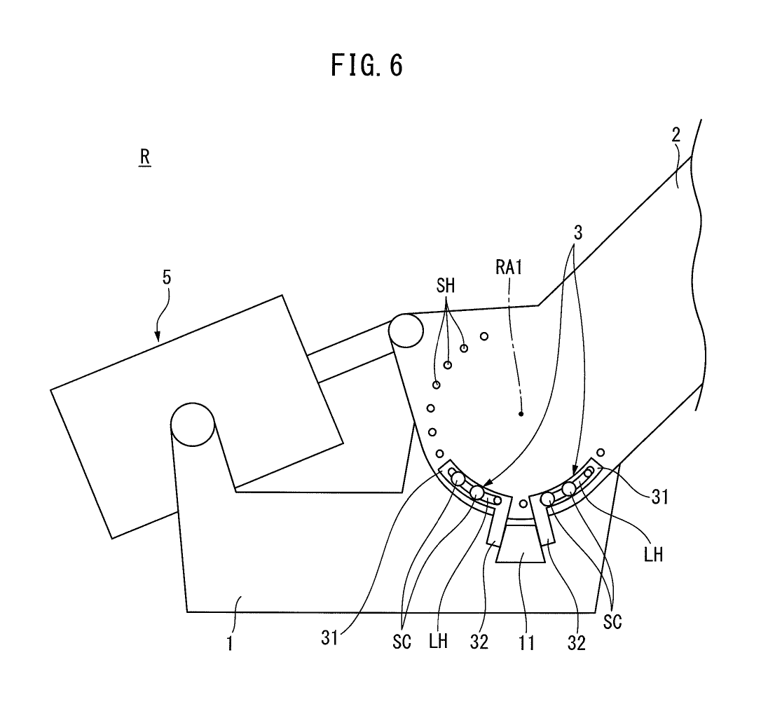

The present invention is not limited to only the above embodiments and can be changed in various ways within the scope of the claims. For example, while the fixing devices 3 of the second embodiment and third embodiment changes the abutting position of the abutting part 32 by rotating a male screw 321 engaging with a female screw 313 of a mounting part 31, but the fixing device 3 of the present invention may also be configured to change the abutting position of the abutting part 32 by means of power source such as air pressure or oil pressure. Further, the above embodiments employs the swivel base 1 as the first member of the robot of the present invention, and the lower arm 2 as the second member, but it is also possible to employ the lower arm 2 as the first member and the swivel base 1 as the second member, on the contrary. FIG. 6 is a partial enlarged view similar to FIG. 2 which shows an illustrative robot R which employs the lower arm 2 as the first member and employs the swivel base 1 as the second member.

As shown in FIG. 6, the structure of each fixing device 3 in the robot R of the present example is similar to the example of FIG. 2. However, in the robot R of the present example, the mounting part 31 of the fixing device 3 is mounted to the lower arm 2 instead of the swivel base 1, and the abutting part 32 of the fixing device 3 abuts against the abuttable part 11 on the swivel base 1 instead of the lower arm 32. More specifically, 16 screw holes SH are formed on the mounting location of the fixing devices 3 to the lower arm 2 of the present example, so as to be arranged at equal intervals in the circumferential direction about the rotation axis RA1. The mounting part 31 of each fixing device 3 is mounted to the lower arm 2 by two mounting screws SC which are inserted in the long hole LH. As shown in FIG. 6, the dimension of the long hole LH in the extension direction is sufficiently larger than the length of the arc which connects two adjoining screw holes SH, and therefore it is possible to steplessly change the mounting position of the mounting part 31 to the lower arm 2 along the extension direction of the long hole LH. Similarly, it is possible to steplessly change the abutting position of the abutting part 32 to the abuttable part 11 of the swivel base 1 along the extension direction of the long hole LH, that is, the circumferential direction about the rotation axis RA1.

Furthermore, the combination of the first member and the second member in the robot of the present invention is not limited to only the above-mentioned combination i.e. the swivel base 1 and the lower arm 2. For example, it is also possible to employ either of the lower arm 2 and upper arm 4 as the first member, and the other of the lower arm 2 and upper arm 4 as the second member, in the robot of the present invention.

1. A robot comprising: a first member and a second member which are connected to be able to rotate relative to each other about a predetermined rotation axis; and a fixing device which restricts relative rotating motion of said first member and said second member about said rotation axis, wherein
said fixing device includes: a mounting part which is mounted to said first member; and
an abutting part which extends from said mounting part and abuts against said second member to restrict said relative rotating motion, and
an abutting position of said abutting part with respect to said second member can be changed steplessly in a circumferential direction about said rotation axis.

2. The robot according to claim 1, wherein
said mounting part has a long hole which extends in said circumferential direction and is mounted to said first member by a plurality of screws which are inserted in said long hole, and
a mounting position of said mounting part to said first member can be changed steplessly along the arrangement direction of the long hole.

3. The robot according to claim 1, wherein
said mounting part and said abutting part are formed of separate members which are connected with each other, and
said abutting part can be moved steplessly with respect to said mounting part in a direction toward an abuttable part of said second member and a direction away from said abuttable part.

4. The robot according to claim 1, further comprising a pair of said fixing devices which are arranged one by one at both sides in said circumferential direction of said abuttable part of said second member.

5. The robot according to claim 2, further comprising a pair of said fixing devices which are arranged one by one at both sides in said circumferential direction of said abuttable part of said second member.

6. The robot according to claim 3, further comprising a pair of said fixing devices which are arranged one by one at both sides in said circumferential direction of said abuttable part of said second member.

7. The robot according to claim 1, wherein
said fixing device includes a pair of said abutting parts which are arranged one by one at both sides in said circumferential direction of the abuttable part of said second member.

8. The robot according to claim 2, wherein
said fixing device includes a pair of said abutting parts which are arranged one by one at both sides in said circumferential direction of the abuttable part of said second member.

9. The robot according to claim 3, wherein
said fixing device includes a pair of said abutting parts which are arranged one by one at both sides in said circumferential direction of the abuttable part of said second member.

10. The robot according to claim 1, further comprising a third member which can be attached to said first member, wherein
said mounting part is mounted by means of said third member to said first member.

11. The robot according to claim 2, further comprising a third member which can be attached to said first member, wherein
said mounting part is mounted by means of said third member to said first member.

12. The robot according to claim 3, further comprising a third member which can be attached to said first member, wherein
said mounting part is mounted by means of said third member to said first member.

13. The robot according to claim 4, further comprising a third member which can be attached to said first member, wherein
said mounting part is mounted by means of said third member to said first member.

14. The robot according to claim 5, further comprising a third member which can be attached to said first member, wherein
said mounting part is mounted by means of said third member to said first member.

15. The robot according to claim 6, further comprising a third member which can be attached to said first member, wherein
said mounting part is mounted by means of said third member to said first member.

16. The robot according to claim 7, further comprising a third member which can be attached to said first member, wherein
said mounting part is mounted by means of said third member to said first member.

17. The robot according to claim 8, further comprising a third member which can be attached to said first member, wherein
said mounting part is mounted by means of said third member to said first member.

18. The robot according to claim 9, further comprising a third member which can be attached to said first member, wherein
said mounting part is mounted by means of said third member to said first member.

19. A fixing device for restricting relative rotating motion about a predetermined rotation axis, of a first member and a second member of a robot which are connected to be able to rotate relative to each other about said rotation axis, comprising:
a mounting part which has a long hole which extends in an arc shape and which can be mounted to said first member by a plurality of screws which are inserted in said long hole; and
an abutting part which extends from said mounting part and abuts against said second member to restrict said relative rotating motion, wherein
a mounting position of said mounting part by said plurality of screws can be changed steplessly along an extension direction of said long hole.

20. A fixing device for restricting relative rotating motion about a predetermined rotation axis, of a first member and a second member in a robot which are connected to be able to rotate relative to each other about said rotation axis, comprising:
a mounting part which can be mounted to said first member; and
an abutting part which extends from said mounting part and abuts against said second member to restrict said relative rotating motion, wherein
said mounting part and said abutting part are formed of separate members which are connected to each other, and
said abutting part can be moved steplessly with respect to said mounting part in a direction toward an abuttable part of said second member and a direction away from said abuttable part.

21. The fixing device according to claim 20, wherein said abutting part is formed of a pair of members which are arranged so as to sandwich said abuttable part of said second member.
